(19) United States
(12) Patent Application Publication
(10) Pub. No.: US 2026/0357077 A1
(43) Pub. Date: Nov. 12, 2026

(54) COATING SOLUTION, MANUFACTURING METHOD OF COATING SOLUTION, AND MANUFACTURING METHOD OF GRAIN-ORIENTED ELECTRICAL STEEL SHEET

(71) Applicant: NIPPON STEEL CORPORATION, Tokyo (JP)

(72) Inventors: Masaru TAKAHASHI, Tokyo (JP); Shuichi YAMAZAKI, Tokyo (JP)

(73) Assignee: NIPPON STEEL CORPORATION, Tokyo (JP)

(21) Appl. No.: 19/121,536

(22) PCT Filed: Nov. 1, 2023
(86) PCT No.: PCT/JP2023/039449

§ 371 Date: Apr. 16, 2025

(30) Foreign Application Priority Data
Nov. 2, 2022 (JP) 2022-176194

(51) Int. Cl. C09D 1/00; C01B 35/12; C09D 5/08; H01F 1/18

(52) U.S. Cl. CPC C09D 1/00; C01B 35/126; C09D 5/084; H01F 1/18

(57) ABSTRACT

The present invention provides a coating solution for forming an insulating film used for a grain-oriented electrical steel sheet, the coating solution including: an aluminum hydroxide particle; and boric acid, wherein the aluminum hydroxide particle has a specific surface area of 20 m²/g or more, and the coating solution has a pH of 5.5 or more. Further, the present invention provides a manufacturing method of a coating solution for forming an insulating film used for a grain-oriented electrical steel sheet. Further, the present invention provides a manufacturing method of a grain-oriented electrical steel sheet using the coating solution.

### TECHNICAL FIELD

The present invention relates to a coating solution, a manufacturing method of a coating solution, and a manufacturing method of a grain-oriented electrical steel sheet.

The present application claims priority based on Japanese Patent Application No. 2022-176194 filed in Japan on Nov. 2, 2022, the contents of which are incorporated herein by reference.

### BACKGROUND ART

A grain-oriented electrical steel sheet has a crystal structure having a {110}<001> orientation as a main orientation and is a steel sheet usually containing 2 mass % or more of Si. The main application thereof includes an iron core material such as a transformer. In particular, a material having a small energy loss during transformation, that is, a material having a low iron loss, is required.

Typically, the manufacturing process of a grain-oriented electrical steel sheet is as follows. First, a slab containing 2 mass % to 4 mass % of Si is hot-rolled, and the hot band is annealed. Next, cold rolling is performed once or twice or more with intermediate annealing interposed therebetween to obtain a final sheet thickness, and decarburization annealing is performed. Thereafter, an annealing separator mainly containing MgO or Al₂O₃ is applied to perform final annealing. As a result, a crystal structure having a {110}<001> orientation as the main orientation is developed, and a final annealing film mainly containing Mg₂SiO₄ is formed on the sheet surface. Finally, a coating solution for forming an insulating film is applied and baked, and then the steel sheet is shipped.

A grain-oriented electrical steel sheet has a property in that the iron loss is improved when the steel sheet is applied with tension. Therefore, when an insulating film made of a material having a thermal expansion coefficient smaller than that of the steel sheet is formed at a high temperature, the steel sheet is applied with tension, and the iron loss can be improved. Conventionally, there have been various known coating solutions for forming an insulating film on an electrical steel sheet.

For example, Patent Document 1 discloses that an insulating film obtained by baking a coating solution containing colloidal silica, mono-phosphate, and chromic acid is excellent in various film characteristics such as tension. For example, Patent Documents 2 to 5 disclose a coating solution for forming an insulating film of a grain-oriented electrical steel sheet mainly containing colloidal silica and mono-phosphate, and using other additives instead of chromic acid.

On the other hand, Patent Documents 6 and 7 disclose a coating solution for forming an insulating film containing alumina sol and boric acid, and a coating solution for forming an insulating film containing alumina sol, boric acid, and colloidal silica. These coating solutions are baked to obtain a film whose main components include a composite oxide of aluminum oxide and boron oxide; or a composite oxide of aluminum oxide and boron oxide, and silica. As disclosed in Patent Document 8 and the like, such a composite oxide is a crystalline aluminum borate represented by the chemical formula xAl₂O₃·yB₂O₃.

Patent Documents 9 and 10 disclose a method of adding an alkali metal compound or an alkaline earth metal compound to a coating solution containing alumina sol and boric acid. Patent Document 11 discloses a method of using, as a coating solution, a water slurry obtained by mixing an aluminum oxide having an average particle size of about 0.4 μm and boric acid, in terms of the molar ratio of Al and B, within a range of Al/B=1.25 to 1.81 to form an aluminum borate film excellent in water resistance and rust resistance.

### CITATION LIST

### Patent Document

Patent Document 1: Japanese Unexamined Patent Application, First Publication No. S48-039338
Patent Document 2: Japanese Examined Patent Application Publication No. S54-143737
Patent Document 3: Japanese Unexamined Patent Application, First Publication No. 2000-169972
Patent Document 4: Japanese Unexamined Patent Application, First Publication No. 2000-178760
Patent Document 5: PCT International Publication No. WO 2015/115036
Patent Document 6: Japanese Unexamined Patent Application, First Publication No. H06-065754
Patent Document 7: Japanese Unexamined Patent Application, First Publication No. H06-065755
Patent Document 8: Japanese Unexamined Patent Application, First Publication No. H06-306628
Patent Document 9: Japanese Unexamined Patent Application, First Publication No. H08-325745
Patent Document 10: Japanese Unexamined Patent Application, First Publication No. H09-256164
Patent Document 11: Japanese Unexamined Patent Application, First Publication No. 2019-137874

### Non Patent Document

Non Patent Document 1: Yoshitane WATANABE, “Synthesis and Properties of Metal Oxid Sols”, Gypsum & Lime, No. 211, p46 (1987)
Non Patent Document 2: Taichi SATO, “Aluminium Hydroxides and Aluminas”, Journal of the Mineralogical Society of Japan, Vol 19, p21 (1989)

### SUMMARY OF INVENTION

### Technical Problem

Each of the conventional techniques has the following problems.

The coating solution for forming an insulating film of Patent Document 1 contains hexavalent chromium. Therefore, in order to improve the work environment in the insulating film forming step of a grain-oriented electrical steel sheet, consideration is given to equipment. In recent years, environmental awareness has increased, and thus desired is the development of a coating solution for forming an insulating film of a grain-oriented electrical steel sheet to obtain an insulating film excellent in various film characteristics such as tension, without containing hexavalent chromium. As in the techniques of Patent Documents 2 to 5, the film tension of an insulating film obtained from a coating solution for forming an insulating film containing no chromic acid and using additives other than chromic acid is smaller than the film tension of an insulating film obtained from a coating solution for forming an insulating film containing chromic acid. In addition, the additives used in the techniques of Patent Documents 2 to 5 all have a problem that they are more expensive than chromic acid.

The insulating film as disclosed in the technique of Patent Documents 6 to 8 does not contain a harmful substance such as chromic acid as is apparent from the constituent components of the coating solution. Furthermore, as compared with an insulating film that is typically used in current grain-oriented electrical steel sheets, for example, an insulating film obtained by baking a coating solution containing colloidal silica, mono-phosphate, and chromic acid disclosed in Patent Document 1, the steel sheet is applied with 1.5 to 2 times of film tension, and the iron loss improving effect is larger than that of the current films. However, an aluminum borate film formed by baking a coating solution containing alumina sol and boric acid has room for further improvement from the viewpoint of corrosion resistance as described in Patent Documents 9 and 10. Patent Documents 9 and 10 disclose a method of adding an alkali metal compound or an alkaline earth metal compound to a coating solution containing alumina sol and boric acid as a measure for improving corrosion resistance. Although these additives are effective to improve the corrosion resistance of the film, the pH of the coating solution is increased by these additives. Therefore, there is a problem that the alumina sol component is sometimes gelled and makes it difficult to stably apply the coating solution to a steel sheet.

The aluminum oxide disclosed in Patent Document 11 is a stable compound and has poor reactivity, and it is not easy to obtain a compound called aluminum borate even if the aluminum oxide is mixed with boric acid and baked. The reason why the aluminum borate film is successively formed in Patent Documents 6 to 10 is that a highly reactive alumina sol is used as an Al source. The alumina sol is not a fine particle of alumina (aluminum oxide) but a dispersion of aluminum oxide hydrate fine particles, and becomes highly reactive when dehydrated by heating. Therefore, a grain-oriented electrical steel sheet on which an insulating film mainly containing aluminum borate and having excellent corrosion resistance is formed has not been successful in industrial production.

The present invention has been made in view of the above, and an object of the present invention is to provide a coating solution for forming an insulating film of a grain-oriented electrical steel sheet that obtains film characteristics including a large film tension, excellent magnetic characteristics, and excellent corrosion resistance without using a harmful substance such as chromic acid; a manufacturing method thereof; and a manufacturing method of a grain-oriented electrical steel sheet.

### Solution to Problem

(1) An embodiment of the present invention is a coating solution for forming an insulating film used for a grain-oriented electrical steel sheet, the coating solution including:
an aluminum hydroxide particle; and boric acid,
in which the aluminum hydroxide particle has a specific surface area of 20 m²/g or more, and
the coating solution has a pH of 5.5 or more.
(2) In the coating solution according to (1), the coating solution may have a pH of 6.0 or more.
(3) In the coating solution according to (1) or (2), the aluminum hydroxide particle may be made of any of gibbsite, bayerite, boehmite, and diaspore, or a combination thereof.
(4) In the coating solution according to any one of (1) to (3), in the coating solution, the aluminum hydroxide particle and the boric acid may be contained in a content ratio of 0.2 to 1.5 in terms of a molar ratio of boron with respect to aluminum.
(5) An embodiment of the present invention is a manufacturing method of a coating solution for forming an insulating film used for a grain-oriented electrical steel sheet, the manufacturing method including:
mixing a dispersion liquid of aluminum hydroxide having a pH of 6.0 or more, and boric acid, or
mixing a boric acid solution in which boric acid is dissolved in a solvent, and an aluminum hydroxide particle having a pH of 6.0 or more when mixed with water; and
manufacturing a coating solution including an aluminum hydroxide particle and boric acid, wherein the aluminum hydroxide particle has a specific surface area of 20 m²/g or more, and the coating solution has a pH of 5.5 or more.
(6) In the manufacturing method of a coating solution according to (5), the coating solution may have a pH of 6.0 or more.
(7) In the manufacturing method of a coating solution according to (5) or (6), the aluminum hydroxide particle may be made of any of gibbsite, bayerite, boehmite, and diaspore, or a combination thereof.
(8) In the manufacturing method of a coating solution according to any one of (5) to (7), in the coating solution, the aluminum hydroxide particle and the boric acid may be contained in a content ratio of 0.2 to 1.5 in terms of a molar ratio of boron with respect to aluminum.
(9) An embodiment of the present invention is a manufacturing method of a grain-oriented electrical steel sheet, the manufacturing method including:
a step of coating a grain-oriented electrical steel sheet having been subjected to final annealing with a coating solution including an aluminum hydroxide particle and boric acid, wherein the aluminum hydroxide particle has a specific surface area of 20 m²/g or more, and the coating solution has a pH of 5.5 or more; and
a step of subjecting the grain-oriented electrical steel sheet coated with the coating solution to a baking treatment at a temperature of 600 °C to 1000 °C.
(10) In the manufacturing method of a grain-oriented electrical steel sheet according to (9), the coating solution may have a pH of 6.0 or more.
(11) In the manufacturing method of a grain-oriented electrical steel sheet according to (9) or (10), the aluminum hydroxide particle may be made of any of gibbsite, bayerite, boehmite, and diaspore, or a combination thereof.
(12) In the manufacturing method of a grain-oriented electrical steel sheet according to any one of (9) to (11), in the coating solution, the aluminum hydroxide particle and the boric acid may be contained in a content ratio of 0.2 to 1.5 in terms of a molar ratio of boron with respect to aluminum.

### Advantageous Effects of Invention

According to the coating solution, the manufacturing method of a coating solution, and the manufacturing method of a grain-oriented electrical steel sheet of the present invention, the coating solution for forming an insulating film for a grain-oriented electrical steel sheet obtains film characteristics including a large film tension, excellent magnetic characteristics, and excellent corrosion resistance without using a harmful substance such as chromic acid.

### DESCRIPTION OF EMBODIMENTS

Hereinafter, an embodiment of the present invention will be described with reference to examples, but it is obvious that the present invention is not limited to the examples described below. In the following description, specific numerical values and materials are sometimes exemplified, but other numerical values and materials may be applied as long as the effects of the present invention can be obtained. In addition, constituent elements of the following embodiment can be combined with each other. In the present specification, a numerical value range indicated by using “to” means a range including the numerical values described before and after “to” as a lower limit and an upper limit. In the present specification, the term “step” includes not only an independent step but also a step that cannot be clearly distinguished from other steps as long as an intended purpose of the step can be achieved.

### <Coating Solution for Forming Insulating Film>

In the coating solution (also referred to as coating solution for forming an insulating film) according to the embodiment, a fine powder of aluminum hydroxide or a dispersion liquid thereof is used as an Al source for forming aluminum borate.

For example, the alumina sol disclosed in Patent Documents 6 to 10 is not a fine particle sol of aluminum oxide as described in Non Patent Document 1, but is a fine particle sol of alumina hydrate. When the alumina hydrate fine particle has a crystal structure close to that of boehmite (AlOOH), the alumina sol is referred to as bochmite sol. As described in Non Patent Document 1, alumina sol and boehmite sol are dehydrated at around 500 °C to become alumina (aluminum oxide), which is an anhydride. The alumina is highly active immediately after dehydration. Therefore, when the alumina is mixed with boric acid and then heated, the alumina can easily react therewith to from aluminum borate. That is, it can be said that the aluminum sol, which is a fine particle sol of alumina hydrate, is a raw material that is easy to synthesize aluminum borate.

As described in Non Patent Document 1, examples of the manufacturing method of alumina sol and bochmite sol include: an ion exchange method in which an excessive anion (Cl or the like) is removed from a basic salt of aluminum (for example, AlOH)xCly) with an ion exchange resin; a neutralization method in which a gel is obtained by neutralizing and washing an acidic salt (for example, AlCl₃), and deflocculated using an acid (for example, HCl); a reaction method in which metal Al is reacted with an acid (for example, HCl) to prepare a basic salt of aluminum (for example, AlOH)xCly), the salt is hydrolyzed to obtain a gel, and the gel is deflocculated using an acid; and an organometallic hydrolysis method in which an aluminum alkoxide is hydrolyzed to obtain a gel, and the gel is deflocculated using an acid. In any of the methods, an acid such as hydrochloric acid, nitric acid, or formic acid is always added for the purpose of stabilizing the sol state (preventing gelation), and the sol becomes acidic. For example, Non Patent Document 1 discloses the pH of an alumina sol is specifically pH 3.8 and pH 4.0. When alumina sol or boehmite sol is added with an alkali or the like to have a pH higher than the original pH, the sol is destabilized and gelled. Therefore, a coating solution for an insulating film using alumina sol or boehmite sol has to be kept acidic.

As described above, although the industrial application work is difficult, excellent corrosion resistance is obtained after baking the insulating film when the pH of the coating solution for an insulating film is increased by adding an alkali metal compound or an alkaline earth metal compound. Accordingly, the present inventors considered that the pH of the coating solution for an insulating film has an influence on the corrosion resistance of the insulating film after baking.

In addition, the Al source exemplified in Patent Document 11 is aluminum oxide. There is a problem that aluminum oxide as an anhydride has lower reactivity than aluminum hydroxide.

On the other hand, a water slurry of aluminum hydroxide is neutral (pH=6 to 7). When boric acid is added thereto, the pH slightly decreases to about 5.5. According to the study of the present inventors, in order to form a dense insulating film, it is necessary to use a fine particle aluminum hydroxide having a large specific surface area, which can be obtained by a mechanical pulverization treatment. However, since a dispersion liquid of a pulverized fine powder aluminum hydroxide has high viscosity and is difficult to handle as a coating solution for an insulating film, a dispersant may need to be added. In this case, the dispersant to be used includes weakly alkaline dispersants such as alkali metal polyphosphate or alkali metal silicate (water glass), and the dispersion liquid of aluminum hydroxide can be pH=8 to 11. When boric acid is further added to the dispersion liquid, the dispersion liquid becomes pH=6 to 9. In the coating solution according to the embodiment, the coating solution becomes neutral or weakly alkaline, where the pH is 5.5 or higher, after boric acid is added. When the coating solution is baked, an insulating film excellent in corrosion resistance is obtained.

Non Patent Document 2 shows that aluminum hydroxide is dehydrated at around 300 °C or around 500 °C. Similarly to alumina sol, aluminum hydroxide is activated in a heating and dehydrating process. Therefore, when aluminum hydroxide is mixed with boric acid and heated, the mixture easily reacts to form aluminum borate. As described above, the present inventors have found that a coating solution that is obtained by adding boric acid to a dispersion liquid of aluminum hydroxide having a pH of 6.0 or more, and has a pH of 5.5 or more can form an insulating film made of aluminum borate when baked at a temperature exceeding the dehydration temperature of aluminum hydroxide, and the insulating film has both high film tension and excellent corrosion resistance when the film can be formed densely.

Hereinafter, each material constituting the coating solution according to the embodiment will be described.

### (Aluminum Hydroxide Particle)

In the embodiment, the coating solution contains an aluminum hydroxide particle. The aluminum hydroxide particle may be contained in one kind or two or more kinds.

In the embodiment, the aluminum hydroxide is preferably an alumina hydrate such as gibbsite and bayalite, each of which is a trihydrate (Al₂O₃·3H₂O); and boehmaite and diaspore, each of which is a monohydrate (Al₂O₃·H₂O). These aluminum hydroxides can be artificially produced by, for example, the method described in Non Patent Document 2. Gibbsite is also referred to as hydragillite. Gibbsite, boehmite, and diaspore are naturally produced as main components of bauxite. These aluminum hydroxides may be used in combination. Among them, gibbsite, bayerite, or a mixture thereof is more preferable from the viewpoint of low dehydration temperature. For example, gibbsite and bayerite, each of which is a trihydrate and has a dehydration temperature of about 300 °C, is highly reactive than a monohydrate, which has a dehydration temperature of about 500 °C, and are excellent in production cost such as time and cost. There is also an advantage that gibbsite and bayerite are easily available.

These aluminum hydroxides are activated by heating and dehydration and react with boric acid to produce aluminum borate. As described above, aluminum oxide has a problem of low reactivity and is not preferable as a raw material for forming an insulating film from the viewpoint of film formation. The alumina sol, the boehmite sol, and the like need to be acidic for stabilization as a sol, and aluminum salts also exhibit acidity, so that there is a problem that corrosion resistance is poor when a coating solution for forming an insulating film is prepared. Therefore, aluminum hydroxide is preferable as an Al source when aluminum borate is formed.

As the aluminum hydroxide particle is finer and has a larger specific surface area, the reaction with boric acid is more easily promoted. Therefore, the specific surface area of the aluminum hydroxide particle is preferably 20 m²/g or more, more preferably 40 m²/g or more, and still more preferably 50 m²/g or more.

On the other hand, the upper limit of the specific surface area is not particularly limited, and the specific surface area may be 200 m²/g or less, 180 m²/g or less, or 150 m²/g or less. When the upper limit of the specific surface area is the above or less, the dispersion stability (viscosity stability) of the coating solution for forming an insulating film is easily maintained. The specific surface area of the aluminum hydroxide particle is a specific surface area based on the BET method and is measured by a method in accordance with JIS Z 8830:2013.

(Manufacture of Aluminum Hydroxide Particle Having Specific Surface Area of 20 m²/g or More)

It is difficult to obtain an industrially used and commercially available aluminum hydroxide having a specific surface area of 20 m²/g or more. For example, C-301N, manufactured by SUMITOMO CHEMICAL COMPANY, LIMITED, is an aluminum hydroxide powder having the smallest particle size among commercial products, and has a specific surface area of about 4 m²/g. By subjecting such a commercially available product to a pulverization treatment, the aluminum hydroxide fine particle having a specific surface area of 20 m²/g or more can be obtained.

As a means for pulverizing aluminum hydroxide, a ball mill, a vibration mill, a bead mill, a jet mill, or the like is effective. As these pulverization means, dry pulverization, in which powder is pulverized as it is, may be adopted, or wet pulverization, which is performed in a state of slurry in which an aluminum hydroxide particle is dispersed in a dispersion medium such as water or alcohol, may be adopted. As the pulverization means, either dry pulverization or wet pulverization is effective. The specific surface area of the aluminum hydroxide particle increases with the pulverization time in either of the various pulverization means. Therefore, the specific surface area of the aluminum hydroxide particle can be managed through pulverization time to obtain an aluminum hydroxide particle having a required specific surface area and the dispersion liquid thereof.

In wet pulverization treatment, the viscosity of the dispersion liquid increases as the specific surface area of the aluminum hydroxide particle increases. When the specific surface area is increased to more than 200 m²/g by pulverization, the viscosity of the dispersion liquid is increased to be gelled, which may interfere with the pulverization treatment. Therefore, a dispersant may be added to the dispersion liquid as necessary.

An increase in viscosity during the pulverization treatment can be suppressed by adding a dispersant. However, among dispersants, when an organic dispersant is added, the organic dispersant may be decomposed and carbonized during baking the insulating film, and may be carburized in the grain-oriented electrical steel sheet. Therefore, when a dispersant is used, an inorganic dispersant is preferable. Furthermore, in order that the pH becomes 6 or more after the dispersant is added, the dispersant is preferably neutral or weakly alkaline. Examples of such an inorganic dispersant include an alkali metal polyphosphate and an alkali metal silicate (water glass). Specific examples of the former dispersant include sodium diphosphate and sodium hexametaphosphate. Specific examples of the latter dispersant include sodium silicate and potassium silicate.

The addition amount of these inorganic dispersants is preferably suppressed to 20 mass % or less with respect to the total mass (100 mass %) of aluminum hydroxide. When the addition amount of the inorganic dispersant is 20 mass % or less, the film composition is less likely to change after baking, and a higher film tension is easily obtained. Since the dispersant is an optional additional component, the lower limit of the dispersant is not particularly limited, and may be 0 mass %. That is, the coating solution may contain no dispersant such as a polyphosphate or water glass. In dry pulverization treatment, it is not necessary to add a dispersant during pulverization, and a dispersant may be added when the dispersion liquid of aluminum hydroxide is prepared.

The content of alkali metal is preferably 5 mass % or less with respect to the total mass of the solid content in the coating solution. When the content of alkali metal is within this range, the coating solution secures an appropriate viscosity and can suppress components not to contribute to film tension. More preferably, the content of alkali metal is 4 mass % or less, or 3 mass % or less, with respect to the total mass of the coating solution. Examples of the alkali metal include Na (sodium), K (potassium), and Li (lithium).

The content of alkali metal in the coating solution is measured using an ICP-AES (inductively coupled plasma-atomic emission spectroscopy) apparatus in accordance with JIS K 0116:2014, General rules for atomic emission spectrometry.

### (Boric Acid)

As the boric acid, one obtained by a known manufacturing method can be used, and either orthoboric acid (H₃BO₃) or meta-boric acid (HBO₂) may be used. As the boric acid, orthoboric acid is preferably used. The boric acid may be used as a particulate boric acid or may be used after being dissolved or dispersed in water. In the case of orthoboric acid, the solubility of boric acid at 20 °C is slightly more than 4 g with respect to 100 g of water. Accordingly, it is necessary to prepare a coating solution while noting that the solubility of boric acid in water or alcohol is small around room temperature. For example, when B/Al=1.5, the addition amount of Al (OH) 3 is 3.4 g with respect to 4 g of orthoboric acid and 100 g of water. The anhydrous solid concentration of the solution (calculated such that B is B₂O₃ and Al is Al₂O₃) remains at 4%. Since the solubility of orthoboric acid increases to slightly more than 8 g at 40 °C, the coating work is easily performed by a means that the coating solution is prepared under heating and coating is performed while the coating solution temperature is being maintained.

### (Content Ratio Between Aluminum Hydroxide Particle and Boric Acid)

The content ratio between the aluminum hydroxide particle and the boric acid in the coating solution is not particularly limited. From the viewpoint of obtaining excellent film tension and excellent corrosion resistance, the content ratio is preferably 1.5 or less in terms of a molar ratio of boron (B) with respect to aluminum (Al) (hereinafter, also referred to as B/Al molar ratio). Boric acid and borate have relatively low solubility in water and alcohol. Therefore, when the B/Al molar ratio is excessively large, the solid content concentration in the coating solution has to be reduced, and it becomes difficult to obtain a target coating amount. Therefore, the upper limit of the B/Al molar ratio is preferably 1.5 or less, preferably 1.3 or less, and more preferably 1.0 or less. From the viewpoint of obtaining excellent film tension and excellent corrosion resistance, the lower limit of the B/Al molar ratio is preferably 0.2 or more. Therefore, the content ratio of the aluminum hydroxide particle and the boric acid is preferably 0.2 to 1.5 in terms of the B/Al molar ratio.

### (Dispersion Medium or Solvent)

As the dispersion medium or solvent used in the coating solution for forming an insulating film, for example, alcohols such as ethyl alcohol, methyl alcohol, and propyl alcohol can be used in addition to water. As the dispersion medium or solvent, water is preferably used from the viewpoint of having no flammability.

The solid content concentration of the coating solution for forming an insulating film is not particularly limited as long as the coating solution can be applied to a grain-oriented electrical steel sheet. The solid content concentration of the coating solution for forming an insulating film is, for example, in a range of 5 to 50 mass % (preferably, 10 mass % to 30 mass %) with respect to the total amount of the coating solution for forming an insulating film.

The solid content concentration of the coating solution for forming an insulating film is the total of the concentration of the aluminum hydroxide particle and the concentration of the boric acid in the coating solution and determined by the method as described below. When the solid content concentration of the coating solution for forming an insulating film is subtracted from the total amount of the coating solution for forming an insulating film, the content of the dispersion medium or solvent is determined.

In addition, the coating solution for forming an insulating film according to the embodiment may contain a small amount of other additives as necessary as long as film tension or corrosion resistance are not impaired. When other additives are contained in a small amount, for example, the additives are preferably 3 mass % or less, and preferably 1 mass % or less, with respect to the total solid content (100 mass %) of the coating solution for forming an insulating film according to the embodiment. Examples of other additives include a surfactant that prevents repelling of the coating solution on a steel sheet. Examples of the surfactant include an alkali metal salt of a carboxylic acid or a sulfonic acid, a quaternary ammonium salt, a fatty acid ester, a polyether, and a higher alcohol.

The coating solution for forming an insulating film according to the embodiment may be made of the aluminum hydroxide particle, the boric acid, and the dispersion medium or solvent.

The viscosity of the coating solution for forming an insulating film is preferably 1 mPa·s to 100 mPa·s from the viewpoint of coating workability and the like. When the viscosity is too high, the application becomes difficult. When the viscosity is too low, the coating solution may flow to make it difficult to obtain a target coating amount. The measurement is performed with a B-type viscometer (Brookfield-type viscometer). The measurement temperature is 25 °C.

From the viewpoint of working environment, the coating solution for forming an insulating film according to the embodiment preferably contains no hexavalent chromium.

The insulating film obtained from the coating solution for forming an insulating film according to the embodiment is baked at a high temperature (for example, 600 °C or higher) in order to have high tension. Therefore, when the coating solution for forming an insulating film contains a resin, the resin is decomposed and carburized by baking. As a result, the magnetic characteristics of the grain-oriented electrical steel sheet are deteriorated. From this viewpoint, the coating solution for forming an insulating film preferably contains no organic component such as a resin.

Here, the coating solution for forming an insulating film according to the embodiment can apply tension to a steel sheet by baking and is suitable as a coating solution for forming an insulating film of a grain-oriented electrical steel sheet. The coating solution for forming an insulating film according to the embodiment can also be applied to a non-oriented electrical steel sheet. However, even when the coating solution for forming an insulating film according to the embodiment is applied to a non-oriented electrical steel sheet, the insulating film does not contain an organic component, and there is no effect of improving punchability of the steel sheet. Therefore, the application to a non-oriented electrical steel sheet is less beneficial.

In preparation of the coating solution for forming an insulating film according to the embodiment, the aluminum hydroxide particle and the boric acid are mixed and stirred with the dispersion medium (solvent). In the coating solution for forming an insulating film according to the embodiment, the coating solution is required to have a pH of 5.5 or more after stirring. When the dispersion medium (solvent) of the coating solution does not sufficiently contain water, the pH cannot be measured or is difficult to measure. Therefore, the coating solution is collected, water is added thereto, the weight ratio of water in the dispersion medium (solvent) is adjusted to 50% or more, and then the pH is checked.

The pH is measured with a pH measuring device.

The order of adding the aluminum hydroxide particle and the boric acid is not particularly limited. For example, optionally, a predetermined amount of the aluminum hydroxide particle is dispersed in a dispersion medium to prepare a dispersion liquid (dispersion liquid of aluminum hydroxide having a pH of 6.0 or more), then a predetermined amount of the boric acid is added thereto, and the mixture is mixed and stirred. When the dispersion medium of the aluminum hydroxide dispersion liquid does not sufficiently contain water, the aluminum hydroxide dispersion liquid is collected and water is added thereto so that the weight ratio of water is 50% or more in the dispersion medium (solvent), and then the pH is checked. When such an aluminum hydroxide dispersion liquid is employed, the coating solution after the boric acid is mixed can have a pH of 5.5 or more. In addition, optionally, a predetermined amount of the boric acid is dissolved in a solvent to prepare a boric acid solution, then a predetermined amount of the aluminum hydroxide particle is added to the boric acid solution, and the mixture is mixed and stirred. The requirement for the aluminum hydroxide particle to be used is that, when mixed with water alone to form a 10 wt % suspension without mixing with the boric acid, the suspension has a pH of 6.0 or more. When such an aluminum hydroxide is employed, the coating solution after the boric acid is mixed can have a pH of 5.5 or more.

The pH of the coating solution after the boric acid is added is more preferably 6.0 or more, more than 6.0, or 6.2 or more, from the viewpoint of more reliably securing corrosion resistance.

The upper limit of the pH of the coating solution after the boric acid is added is more preferably 10, or 9 or less, from the viewpoint of suppressing the content of alkali metal in order to prevent a decrease in film tension.

In addition, if necessary, other additives may be added and mixed and stirred. Then, the coating solution for forming an insulating film may be adjusted to have an intended solid content concentration. The liquid temperature of the coating solution may be heated (for example, 50 °C), or may be room temperature (for example, 25 °C.).

The dispersion liquid in which the aluminum hydroxide particle is dispersed preferably has a pH of 6.0 or more from the viewpoint that the coating solution has a pH of 5.5 or more after the boric acid is added, and a pH of 6.5 or more from the viewpoint that more reliable corrosion resistance is secured.

The upper limit of the pH of the dispersion liquid in which the aluminum hydroxide particle is dispersed is preferably 12, or 11, from the viewpoint of suppressing the alkali metal content.

### (Analysis of Components in Coating Solution)

In the coating solution for forming an insulating film according to the embodiment, the content of each of the aluminum hydroxide particle and the boric acid in the coating solution can be measured as follows.

Specifically, first, the coating solution for forming an insulating film is filtered. In the coating solution in which the aluminum hydroxide particle and the boric acid are mixed, both hardly react at 100 °C or less. Therefore, the coating solution at 100 °C or lower is, for example, in a slurry state in which the aluminum hydroxide particle is dispersed in the boric acid aqueous solution. When the coating solution is filtered, the coating solution is separated into a filtrate containing a boric acid aqueous solution derived from the boric acid before mixing and a residue containing a hydrous silicate derived from the aluminum hydroxide particle. Next, the filtrate is subjected to ICP-AES analysis (inductively coupled plasma-atomic emission spectrometry) to determine the concentration of B, and the concentration of the boric acid in the coating solution can be determined by calculating from the concentration of B. In addition, the weight of the residue is measured and compared with the weight of the dispersion liquid before filtration, whereby the concentration of the aluminum hydroxide in the coating solution can be determined. The inclusion of Al can be measured by fluorescent X-ray measurement, and the presence of the aluminum hydroxide particle can be measured by X-ray diffraction. From the concentration of the boric acid and the concentration of the aluminum hydroxide in the coating solution, the molar ratio of boron with respect to aluminum (B/Al) is determined. Furthermore, the specific surface area of the aluminum hydroxide particle is determined from the residues separated above by the BET method described above.

### <Grain-Oriented Electrical Steel Sheet and Manufacturing Method of Grain-Oriented Electrical Steel Sheet>

Next, an example of the preferred embodiment of the grain-oriented electrical steel sheet and the manufacturing method of a grain-oriented electrical steel sheet according to the embodiment will be described. The grain-oriented electrical steel sheet according to the embodiment includes: a grain-oriented electrical steel sheet as a base metal; and an insulating film provided on the grain-oriented electrical steel sheet as a base metal, wherein the insulating film includes a crystal of aluminum borate made of constituent elements including Al, B, and O. A glass film or an oxide film may be formed between the base metal and the insulating film, or the insulating film may be directly formed on the base metal.

The grain-oriented electrical steel sheet according to the embodiment is preferably obtained by the manufacturing method described below.

The manufacturing method of a grain-oriented electrical steel sheet according to the embodiment includes a step in which a grain-oriented electrical steel sheet after final annealing (that is, grain-oriented electrical steel sheet as a base metal) is coated with a coating solution for forming an insulating film of a grain-oriented electrical steel sheet according to the embodiment, and then subjected to a baking treatment at a baking temperature of 600 °C to 1000 °C.

(Grain-Oriented Electrical Steel Sheet after Final Annealing)

The grain-oriented electrical steel sheet after final annealing is a grain-oriented electrical steel sheet that serves as a base metal before the coating solution (that is, coating solution for forming an insulating film according to the embodiment) is applied. The grain-oriented electrical steel sheet after final annealing is not particularly limited. As a preferred example, the grain-oriented electrical steel sheet as a base metal is obtained as follows. Specifically, for example, a steel piece containing 2 mass % to 4 mass % of Si is subjected to hot rolling, hot-band annealing, and cold rolling, and then subjected to decarburization annealing. Thereafter, an annealing separator containing MgO in an amount of 50 mass % or more is applied, and final annealing is performed to obtain the base metal. The grain-oriented electrical steel sheet after final annealing may have no final annealing film.

(Application and Baking Treatment of Coating Solution for Forming Insulating Film)

The grain-oriented electrical steel sheet after final annealing is coated with the coating solution for forming an insulating film according to the embodiment, and then subjected to baking treatment. The application amount is not particularly limited. From the viewpoint of obtaining excellent film tension and excellent corrosion resistance, the application is preferably performed so that the film amount is within a range of 1 g/m2 to 10 g/m2 per one surface after an insulating film is formed. More preferably, the film amount is 2 g/m2 to 8 g/m2. The application amount after the baking treatment can be determined from the weight difference before and after the insulating film is removed.

The excellent film tension and corrosion resistance may mean being equal to or higher than that of a conventional insulating film, especially, an insulating film using a coating solution containing a chromium compound. In the Reference Example (an insulating film using a coating solution containing a chromium compound) described later, the film tension is 8 MPa, and the corrosion resistance is 0%. In Comparative Example 1 (an insulating film using a coating solution containing alumina sol and boric acid) described later, the film tension is 15 MPa, and the corrosion resistance is 100%. In the insulating film according to the embodiment, the film tension may be 8 MPa or more, preferably 10 MPa or more, and more preferably 12 MPa or more, in consideration of acceptable likelihood. The corrosion resistance may be 10% or less, preferably 5% or less, more preferably 1% or less, or 0%.

The application method of the coating solution for forming an insulating film on the grain-oriented electrical steel sheet after final annealing is not particularly limited. Examples thereof include application methods such as a roll method, a spray method, and a dip method.

After the coating solution for forming an insulating film is applied, baking is performed. When the baking temperature (reaching sheet temperature) is lower than 600 °C, aluminum borate is insufficiently produced through the reaction between the aluminum hydroxide particle and the boric acid. Therefore, the baking temperature is 600 °C or higher. The lower limit of the baking temperature is preferably 700 °C or higher. On the other hand, when the baking temperature is higher than 1000 °C, the grain-oriented electrical steel sheet is easily softened and distorted. Accordingly, the baking temperature is 1000 °C or lower. The upper limit is preferably 950 °C or lower. The baking time is preferably 5 seconds to 300 seconds, and preferably 10 seconds to 120 seconds. The heating method for performing the baking treatment is not particularly limited. Examples thereof include a radiation furnace, a hot blast furnace, and induction heating.

The insulating film after the baking treatment is a dense film. The thickness of the insulating film is preferably 0.5 μm to 5 μm (preferably 1 μm to 4 μm). The thickness of the insulating film after the baking treatment can be determined by cross-sectional SEM observation.

Through the above steps, from the coating solution for forming an insulating film according to the embodiment, a grain-oriented electrical steel sheet excellent in both characteristics, film tension and corrosion resistance, is obtained even when no chromium compound is contained. In addition, the grain-oriented electrical steel sheet provided with an insulating film from the coating solution for forming an insulating film according to the embodiment is also excellent in magnetic characteristics.

Although an example of the preferred embodiment of the present invention has been described, the present invention is not limited to the above. The above is an example, and anything having substantially the identical configuration as the technical idea described in the claims of the present invention and exhibiting similar operation and effects is included in the technical scope of the present invention.

### EXAMPLES

Hereinafter, the present invention will be specifically described with reference to examples, but the present invention is not limited thereto.

### Experimental Example 1

First, commercially available gibbsite (hydrargillite), bayerite, bochmite, and diaspore powders (The specific surface area was 4, 2, 16, and 1 m²/g, respectively.) were prepared. As shown in Table 1, these were used as they were in Comparative Examples 5 to 8, and were subjected to pulverization treatment by each pulverization means in other comparative examples and examples. In the pulverization treatment, a dispersant was used as necessary. In wet pulverization, the dispersant was added during water slurry preparation before the treatment. In dry pulverization, the dispersant was added during coating solution adjustment after the pulverization treatment. The dispersant used was sodium diphosphate or sodium hexametaphosphate, and the addition amount thereof was 3 mass % with respect to aluminum hydroxide. The pH of the slurry was measured after the pulverization treatment. After drying at 120 °C, the specific surface area of the aluminum particle was measured in accordance with the method (carrier gas method) described in JIS Z 8830:2013.

Boric acid was added to the aluminum hydroxide slurry to prepare a coating solution having the composition shown in Table 1, and the pH was checked. The B/Al shown in Table 1 is a calculated value obtained by mixing and adjusting the aluminum hydroxide particle and the boric acid so that the molar ratio B/Al was each value. That is, the addition amount of the boric acid can be calculated from the molar ratio of boron with respect to aluminum B/Al shown in Table 1. In Comparative Example 3, boric acid was not added, and B/Al was 0. In Comparative Example 4, a predetermined amount of acetic acid was added to the aluminum hydroxide slurry to adjust the pH to 5.0. The coating solutions shown in Examples 21 and 30 are examples in which two kinds of aluminum hydroxide particles are used in mixture. In the following tables, underlined numerical values and the like indicate that they are out of the preferable conditions of the present invention.

TABLE 1

| | Coating solution composition | | | | | | |
|---|---|---|---|---|---|---|---|
| | Slurry of alumina sol, boehmite sol, or aluminum hydroxide | | | | | | |
| | | | | Specific | | Coating solution | |
| | | | | surface | | B/AI | pH of |
| | | Pulverization | | area | | (molar | coating |
| | Name | means | Dispersant | (m²/g) | pH | ratio) | solution |
| Reference | Reference coating solution | | | | | | |
| Example | | | | | | | |
| Comparative | Alumina sol | — | — | 300 | 4.5 | 0.5 | 3.5 |
| Example 1 | | | | | | | |
| Comparative | Boehmite sol | — | — | 200 | 4.0 | 0.5 | 2.7 |
| Example 2 | | | | | | | |
| Comparative | Gibbsite | JM | SHMP | 100 | 7.0 | 0 | 7.0 |
| Example 3 | | | | | | | |
| Comparative | Gibbsite | JM | SHMP | 100 | 7.0 | 0.5 | 5.0 |
| Example 4 | | | | | | | |
| Comparative | Gibbsite | None | None | 4 | 7.0 | 0.5 | 6.0 |
| Example 5 | | | | | | | |
| Comparative | Bayerite | None | None | 2 | 7.0 | 0.5 | 6.0 |
| Example 6 | | | | | | | |
| Comparative | Boehmite | None | None | 16 | 7.0 | 0.5 | 6.0 |
| Example 7 | | | | | | | |
| Comparative | Diaspore | None | None | 1 | 7.0 | 0.5 | 6.0 |
| Example 8 | | | | | | | |
| Example 1 | Gibbsite | BW | None | 20 | 7.0 | 0.2 | 6.0 |
| Example 2 | Gibbsite | BW | None | 20 | 7.0 | 0.4 | 6.0 |
| Example 3 | Gibbsite | BW | None | 20 | 7.0 | 0.6 | 6.0 |
| Example 4 | Gibbsite | BW | None | 20 | 7.0 | 0.8 | 6.0 |
| Example 5 | Gibbsite | BW | None | 20 | 7.0 | 1.0 | 6.0 |
| Example 6 | Gibbsite | BD | SDP | 50 | 9.0 | 0.2 | 6.8 |
| Example 7 | Gibbsite | BD | SDP | 50 | 9.0 | 0.4 | 6.6 |
| Example 8 | Gibbsite | BD | SDP | 50 | 9.0 | 0.6 | 6.4 |
| Example 9 | Gibbsite | BD | SDP | 50 | 9.0 | 0.8 | 6.2 |
| Example 10 | Gibbsite | BD | SDP | 50 | 9.0 | 1.0 | 6.0 |
| Example 11 | Gibbsite | JM | SHMP | 100 | 7.0 | 0.1 | 6.9 |
| Example 12 | Gibbsite | JM | SHMP | 100 | 7.0 | 0.2 | 6.8 |
| Example 13 | Gibbsite | JM | SHMP | 100 | 7.0 | 0.4 | 6.6 |
| Example 14 | Gibbsite | JM | SHMP | 100 | 7.0 | 0.6 | 6.4 |
| Example 15 | Gibbsite | JM | SHMP | 100 | 7.0 | 0.8 | 6.2 |
| Example 16 | Gibbsite | JM | SHMP | 100 | 7.0 | 1.0 | 6.0 |
| Example 17 | Gibbsite | BM | SDP | 150 | 7.1 | 0.1 | 6.9 |
| Example 18 | Gibbsite | BM | SDP | 150 | 7.1 | 0.2 | 6.8 |
| Example 19 | Gibbsite | BM | SDI | 150 | 7.1 | 0.6 | 6.4 |
| Example 20 | Gibbsite | BM | SDP | 150 | 7.1 | 0.8 | 6.2 |
| Example 21 | Gibbsite | BW | SHMP | 100 | 7.0 | 0.6 | 6.4 |
| | Boehmite | BW | SHMP | 50 | | | |
| Example 22 | Bayerite | BW | None | 20 | 7.0 | 0.6 | 6.4 |
| Example 23 | Boehmite | BW | SDP | 50 | 9.0 | 0.2 | 6.8 |
| Example 24 | Bochmite | BW | SDP | 50 | 9.0 | 0.4 | 6.6 |
| Example 25 | Boehmite | BW | SDP | 50 | 9.0 | 0.6 | 6.4 |
| Example 26 | Boehmite | BW | SDP | 50 | 9.0 | 0.8 | 6.2 |
| Example 27 | Boehmite | BW | SDP | 50 | 9.0 | 1.0 | 6.0 |
| Example 28 | Bayerite | BW | SHMP | 100 | 7.0 | 0.6 | 6.4 |
| Example 29 | Diaspore | BW | SHMP | 150 | 7.0 | 0.6 | 6.4 |
| Example 30 | Gibbsite | BW | SHMP | 100 | 7.0 | 0.4 | 6.6 |
| | Diaspore | BW | SHMP | 150 | | | |
| Example 31 | Gibbsite | BD | SHMP | 50 | 9.0 | 1.3 | 5.7 |
| Example 32 | Gibbsite | BD | SHMP | 50 | 9.0 | 1.5 | 5.5 |

In Table 1, the composition of the reference coating solution is as follows.
An aqueous dispersion of 20 mass % colloidal silica: 100 parts by mass
An aqueous solution of 50 mass % aluminum phosphate: 60 parts by mass
Chromic acid anhydride: 6 parts by mass

In Table 1, Comparative Example 1 is an example using a commercially available amorphous alumina sol. Similarly, Comparative Example 2 is an example using a commercially available boehmite sol. In the same manner as in the above-described aluminum hydroxide slurry, the pH and the specific surface area of the aluminum particle were measured.

In Table 1, the pulverization means are as follows.
JM: Jet mill (dry)
BD: Ball mill (dry)
BW: Ball mill (wet)
BM: Bead mill (wet)
In Table 1, the dispersants are as follows.
SDP: Sodium diphosphate
SHMP: Sodium hexametaphosphate

A final-annealed grain-oriented electrical steel sheet having a final annealing film and having a sheet thickness of 0.23 mm (B₈=1.93 T) was prepared. The coating solution having the composition shown in Table 1 was applied and dried thereon such that the amount of the insulating film was 5 g/m² after baking treatment, and a baking treatment was performed under the conditions of 850 °C and 30 seconds.

The film characteristics (corrosion resistance and film tension) and magnetic characteristics (magnetic flux density and iron loss) of the obtained grain-oriented electrical steel sheet with an insulating film were evaluated. The evaluation results are shown in Table 2.

TABLE 2

| | | | Magnetic characteristics | |
|---|---|---|---|---|
| | Film characteristics | | Magnetic | |
| | Corrosion | | flux density | Iron loss |
| | resistance | Film tension | B₈ | W_{17/50} |
| | (%) | (MPa) | (T) | (W/kg) |
| Reference | 0 | 8 | 1.93 | 0.85 |
| Example | | | | |
| Comparative | 50 | 15 | 1.93 | 0.77 |
| Example 1 | | | | |
| Comparative | 50 | 13 | 1.93 | 0.79 |
| Example 2 | | | | |
| Comparative | 30 | 2 | 1.93 | 1.02 |
| Example 3 | | | | |
| Comparative | 50 | 16 | 1.93 | 0.77 |
| Example 4 | | | | |
| Comparative | 30 | 4 | 1.93 | 0.95 |
| Example 5 | | | | |
| Comparative | 30 | 3 | 1.93 | 0.99 |
| Example 6 | | | | |
| Comparative | 30 | 5 | 1.93 | 0.90 |
| Example 7 | | | | |
| Comparative | 30 | 3 | 1.93 | 0.99 |
| Example 8 | | | | |
| Example 1 | 0 | 13 | 1.93 | 0.79 |
| Example 2 | 0 | 14 | 1.93 | 0.78 |
| Example 3 | 0 | 14 | 1.93 | 0.78 |
| Example 4 | 0 | 14 | 1.93 | 0.78 |
| Example 5 | 0 | 14 | 1.93 | 0.78 |
| Example 6 | 0 | 14 | 1.93 | 0.78 |
| Example 7 | 0 | 15 | 1.93 | 0.77 |
| Example 8 | 0 | 15 | 1.93 | 0.77 |
| Example 9 | 0 | 15 | 1.93 | 0.77 |
| Example 10 | 0 | 15 | 1.93 | 0.77 |
| Example 11 | 0 | 8 | 1.93 | 0.85 |
| Example 12 | 0 | 15 | 1.93 | 0.77 |
| Example 13 | 0 | 16 | 1.93 | 0.77 |
| Example 14 | 0 | 16 | 1.93 | 0.77 |
| Example 15 | 0 | 16 | 1.93 | 0.77 |
| Example 16 | 0 | 16 | 1.93 | 0.77 |
| Example 17 | 0 | 8 | 1.93 | 0.85 |
| Example 18 | 0 | 15 | 1.93 | 0.77 |
| Example 19 | 0 | 16 | 1.93 | 0.77 |
| Example 20 | 0 | 16 | 1.93 | 0.77 |
| Example 21 | 0 | 16 | 1.93 | 0.77 |
| Example 22 | 0 | 14 | 1.93 | 0.78 |
| Example 23 | 0 | 14 | 1.93 | 0.78 |
| Example 24 | 0 | 15 | 1.93 | 0.77 |
| Example 25 | 0 | 15 | 1.93 | 0.77 |
| Example 26 | 0 | 15 | 1.93 | 0.77 |
| Example 27 | 0 | 15 | 1.93 | 0.77 |
| Example 28 | 0 | 16 | 1.93 | 0.77 |
| Example 29 | 0 | 16 | 1.93 | 0.77 |
| Example 30 | 0 | 16 | 1.93 | 0.77 |
| Example 31 | 0 | 16 | 1.93 | 0.77 |
| Example 32 | 0 | 16 | 1.93 | 0.77 |

The evaluation method of each evaluation shown in Table 2 is as follows.

### (Corrosion Resistance)

A test piece having a size of 150 mm×60 mm was prepared from the grain-oriented electrical steel sheet with an insulating film, and the corrosion resistance was evaluated in accordance with the “neutral salt spray testing” described in JIS Z 2371:2015 Methods of salt spray testing. That is, while the test piece was maintained at 35 °C, a 5 mass % NaCl aqueous solution adjusted to pH=7.0 was continuously sprayed onto the test piece, the rust generation state was observed after 48 hours, and the area fraction of the rust area to the surface area of the test piece was calculated.

### (Film Tension)

The film tension was calculated from warpage of the steel sheet caused when the insulating film was removed at one surface. Specific conditions were as follows. From the grain-oriented electrical steel sheet on both surface of which an insulating film has been formed, a test piece having a size of 300 mm×30 mm was prepared. After one surface was covered with a protective tape, the test piece was immersed in an alkaline aqueous solution to remove only the insulating film on the other surface. Thereafter, the curved shape of the grain-oriented electrical steel sheet was measured to calculate the radius of curvature, and the film tension was determined by the following Expression 1.

Film tension (MPa)=55000×Sheet thickness (m)/Radius of curvature (m) Expression 1

### (Iron Loss and Magnetic Flux Density)

The iron loss and the magnetic flux density were measured in accordance with the method described in JIS C 2550-1:2011. Specifically, the iron loss per unit mass (W 17/50) was measured under the conditions where the measurement magnetic flux density has an amplitude of 1.7 T and a frequency of 50 Hz. As the magnetic flux density (Ba), the value of the magnetic flux density was measured at a magnetizing force of 800 A/m.

As shown in Tables 1 and 2, it can be seen that the insulating film is excellent in film tension and magnetic characteristics, but is remarkably poor in corrosion resistance in Comparative Example 1, which was obtained from the coating solution containing alumina sol and boric acid, and in Comparative Example 2, which was obtained from the coating solution containing boehmite sol and boric acid. In Comparative Examples 5 to 8, in which an aluminum hydroxide having a small specific surface area was used instead of alumina sol, the reactivity with boric acid is poor, aluminum borate is insufficiently formed, and the film has insufficient denseness, so that the film tension is small and the corrosion resistance is also poor.

In Comparative Example 3, in which boric acid was not added, no film was formed, and aluminum hydroxide anhydride, that is, fine powder of aluminum oxide was attached to the sheet surface. In Comparative Example 4, in which the pH of the coating solution was less than 5.5, a film applying tension to the steel sheet was formed, but the corrosion resistance was insufficient, which was the same result as in the case where alumina sol and boric acid were used.

In Table 1, each of Examples 1 to 32 is an insulating film formed using the coating solution for forming an insulating film containing the pulverized aluminum hydroxide particle and the boric acid. As shown in Table 2, the insulating films of the examples had large film tension and excellent corrosion resistance. Furthermore, the insulating films of examples were also excellent in magnetic properties. In addition, it has been found that the insulating film of each of the examples can achieve performance equal to or higher than that of the film using the coating solution containing a chromium compound as shown in the Reference Example.

Therefore, it can be seen that the grain-oriented electrical steel sheet obtained using the coating solution for forming an insulating film according to the embodiment has a densified insulating film, so that film characteristics of large film tension and excellent corrosion resistance can be obtained without using a chromium compound. In addition, it is found that these film characteristics are obtained, and the magnetic characteristics and the space factor are also excellent.

### Experimental Example 2

In Experimental Example 2, corrosion resistance was evaluated under more severe corrosion conditions. A test piece having a size of 150 mm×60 mm was newly prepared from the electrical steel sheet with an insulating film in Examples 6 to 10, 31, and 32 in Table 1, and the corrosion resistance was evaluated in accordance with the “acetic acid salt spray testing” described in JIS Z 2371:2015 Methods of salt spray testing. That is, while the test piece was maintained at 35 °C, a 5 mass % NaCl aqueous solution adjusted to pH=3.0 was continuously sprayed onto the test piece, the rust generation state was observed after 48 hours, and the area fraction of the rust area to the surface area of the test piece was calculated.

Table 3 shows corrosion resistance evaluation results of Experimental Example 2. The acceptance criteria for corrosion resistance of the film was set to 1.0%, and a film having corrosion resistance of 1.0% or less was regarded as good in this experiment. In Examples 31 and 32, although rust was not generated in the neutral salt spray testing in Example 1, it is found that rust generation cannot be completely suppressed in the acetic acid salt spray testing. On the other hand, in Examples 6 to 10, it is found that rust generation can be prevented even in the acetic acid salt spray testing, where the corrosion conditions are more severe.

TABLE 3

| | | Corrosion |
|---|---|---|
| | pH of | resistance |
| | coating | of film |
| | solution | (%) |
| Example 6 | 6.8 | 0 |
| Example 7 | 6.6 | 0 |
| Example 8 | 6.4 | 0 |
| Example 9 | 6.2 | 0 |
| Example 10 | 6.0 | 0.5 |
| Example 31 | 5.7 | 5 |
| Example 32 | 5.5 | 10 |

### Experimental Example 3

In Experimental Example 3, film characteristics and magnetic characteristics were evaluated where the insulating film were formed at a different baking temperature. The coating solution was adjusted to have the same composition as in Example 9 of Experimental Example 1, applied and dried in the same procedure as in Experimental Example 1 so that the amount of the insulating film was 5 g/m² after the baking treatment, and baked under the conditions where the baking temperature was changed as shown in Table 4. The baking time was 30 seconds. The results are shown in Table 4.

TABLE 4

| | | | | Magnetic characteristics | |
|---|---|---|---|---|---|
| | | | | Magnetic | |
| | Baking | Film characteristics | | flux | |
| | tempera- | Corrosion | Film | density | Iron loss |
| | ture | resistance | tension | B₈ | W_{17/50} |
| | (°C) | (%) | (MPa) | (T) | (W/kg) |
| Comparative | 500 | 50 | 2 | 1.93 | 1.10 |
| Example 9 | | | | | |
| Comparative | 550 | 30 | 4 | 1.93 | 0.95 |
| Example 10 | | | | | |
| Example 33 | 600 | 1.0 | 13 | 1.93 | 0.79 |
| Example 34 | 700 | 0 | 14 | 1.93 | 0.78 |
| Example 35 | 950 | 0 | 15 | 1.93 | 0.77 |
| Example 36 | 1000 | 0 | 16 | 1.93 | 0.77 |

As shown in Table 4, in Comparative Examples 9 and 10, in which the baking temperature was lower than 600 °C, the film tension was small. This is presumably because the reaction between the aluminum hydroxide particle and the boric acid is not sufficient. On the other hand, it is found that excellent film tension and magnetic properties are obtained in Examples 33 to 36, in which the baking temperature is 600 °C or higher.

Although the preferred embodiments of the present invention have been described above, the present invention is not limited to such examples. It is obvious that those skilled in the art can conceive various changes or modifications within the scope of the idea described in the claims, and it is understood that those changes or modifications naturally belong to the technical scope of the present invention.

### INDUSTRIAL APPLICABILITY

According to the coating solution, the manufacturing method thereof, and the manufacturing method of a grain-oriented electrical steel sheet of the present invention, film characteristics including a large film tension, excellent magnetic characteristics, and excellent corrosion resistance are obtained without using a harmful substance such as chromic acid. Thus, the present invention is industrially extremely useful.

1. A coating solution for forming an insulating film used for a grain-oriented electrical steel sheet, the coating solution comprising:
an aluminum hydroxide particle; and boric acid,
wherein the aluminum hydroxide particle has a specific surface area of 20 m²/g or more, and
the coating solution has a pH of 5.5 or more.

2. The coating solution according to claim 1, wherein
the coating solution has a pH of 6.0 or more.

3. The coating solution according to claim 1, wherein
the aluminum hydroxide particle is made of any of gibbsite, bayerite, boehmite, and diaspore, or a combination thereof.

4. The coating solution according to claim 1, wherein
in the coating solution, the aluminum hydroxide particle and the boric acid are contained in a content ratio of 0.2 to 1.5 in terms of a molar ratio of boron with respect to aluminum.

5. A manufacturing method of a coating solution for forming an insulating film used for a grain-oriented electrical steel sheet, the manufacturing method comprising:
mixing a dispersion liquid of aluminum hydroxide having a pH of 6.0 or more, and boric acid, or
mixing a boric acid solution in which boric acid is dissolved in a solvent, and an aluminum hydroxide particle having a pH of 6.0 or more when mixed with water; and
manufacturing a coating solution including an aluminum hydroxide particle and boric acid, wherein the aluminum hydroxide particle has a specific surface area of 20 m²/g or more, and the coating solution has a pH of 5.5 or more.

6. The manufacturing method of a coating solution according to claim 5, wherein
the coating solution has a pH of 6.0 or more.

7. The manufacturing method of a coating solution according to claim 5, wherein
the aluminum hydroxide particle is made of any of gibbsite, bayerite, boehmite, and diaspore, or a combination thereof.

8. The manufacturing method of a coating solution according to claim 5, wherein
in the coating solution, the aluminum hydroxide particle and the boric acid are contained in a content ratio of 0.2 to 1.5 in terms of a molar ratio of boron with respect to aluminum.

9. A manufacturing method of a grain-oriented electrical steel sheet, the manufacturing method comprising:
a step of coating a grain-oriented electrical steel sheet having been subjected to final annealing with a coating solution including an aluminum hydroxide particle and boric acid, wherein the aluminum hydroxide particle has a specific surface area of 20 m²/g or more, and the coating solution has a pH of 5.5 or more; and
a step of subjecting the grain-oriented electrical steel sheet coated with the coating solution to a baking treatment at a temperature of 600 °C to 1000 °C.

10. The manufacturing method of a grain-oriented electrical steel sheet according to claim 9, wherein
the coating solution has a pH of 6.0 or more.

11. The manufacturing method of a grain-oriented electrical steel sheet according to claim 9, wherein
the aluminum hydroxide particle is made of any of gibbsite, bayerite, boehmite, and diaspore, or a combination thereof.

12. The manufacturing method of a grain-oriented electrical steel sheet according to claim 9, wherein,
in the coating solution, the aluminum hydroxide particle and the boric acid are contained in a content ratio of 0.2 to 1.5 in terms of a molar ratio of boron with respect to aluminum.

13. The coating solution according to claim 2, wherein
the aluminum hydroxide particle is made of any of gibbsite, bayerite, boehmite, and diaspore, or a combination thereof.

14. The coating solution according to claim 2, wherein
in the coating solution, the aluminum hydroxide particle and the boric acid are contained in a content ratio of 0.2 to 1.5 in terms of a molar ratio of boron with respect to aluminum.

15. The manufacturing method of a coating solution according to claim 6, wherein
the aluminum hydroxide particle is made of any of gibbsite, bayerite, boehmite, and diaspore, or a combination thereof.

16. The manufacturing method of a coating solution according to claim 6, wherein
in the coating solution, the aluminum hydroxide particle and the boric acid are contained in a content ratio of 0.2 to 1.5 in terms of a molar ratio of boron with respect to aluminum.

17. The manufacturing method of a grain-oriented electrical steel sheet according to claim 10 wherein
the aluminum hydroxide particle is made of any of gibbsite, bayerite, boehmite, and diaspore, or a combination thereof.

18. The manufacturing method of a grain-oriented electrical steel sheet according to claim 10, wherein,
in the coating solution, the aluminum hydroxide particle and the boric acid are contained in a content ratio of 0.2 to 1.5 in terms of a molar ratio of boron with respect to aluminum.
